(19) United States
(12) Patent Application Publication
(10) Pub. No.: US 2025/0373979 A1
(43) Pub. Date: Dec. 4, 2025

(54) SOUND OUTPUT DEVICE AND AUDIO DATA INTERRUPTION PROTECTION METHOD THEREOF

(71) Applicant: NUVOTON TECHNOLOGY CORPORATION, HSINCHU CITY (TW)

(72) Inventor: Wei-Fan Lin, Zhubei City (TW)

(21) Appl. No.: 18/955,163

(22) Filed: Nov. 21, 2024

(30) Foreign Application Priority Data
Jun. 3, 2024 (TW) 113120454

(51) Int. Cl. H04R 3/00

(52) U.S. Cl. CPC H04R 3/00

(57) ABSTRACT

The preferred embodiment of the present disclosure relates to a sound output device and an audio data interruption protection method thereof for driving a speaker equipment. The sound output device includes: a First-In-First-Out (FIFO) buffer configured to receive and output audio data; a buffer circuit configured to temporarily store the received audio data; and a pop noise protection device. The pop noise protection device is configured to receive the audio data from the buffer circuit to drive the speaker equipment. When the pop noise protection device receives an underflow notification from the FIFO buffer, the pop noise protection device obtains the last audio data from the buffer circuit and gradually reduces volume of the last audio data to avoid the occurrence of pop noise. This design effectively prevents sudden pops of noise caused by interruptions of the audio data, protecting the speaker equipment and the hearing of users.

### CROSS-REFFERENCE TO RELATED APPLICATION

This application claims the priority from the TW Patent Application No. 113120454, filed on June 3, 2024, and all contents of such TW Patent Application are comprised in the present disclosure.

### BACKGROUND

### 1. Field of the Invention

The present disclosure is related to technologies for sound playback and digital data transmission, and in particular to a sound output device and an audio data interruption protection method thereof.

### 2. Description of the Related Art

In modern microcontroller units (MCUs), the key to audio reception and playback lies in the First-In-First-Out (FIFO) buffer technology. This technology allows the MCU to temporarily store the received audio data in the FIFO buffer, then sequentially read the audio data from the FIFO buffer in a first-in-first-out order according to the timing of the audio sampling rate and send the audio data to the audio output terminal. This advanced buffer design ensures the continuity of the audio data and prevents interruptions and distortions in audio playback.

However, in practical applications, underflow may occur in the FIFO buffer due to insufficient replenishment of audio data. When the MCU needs to read audio data from the FIFO buffer, the buffer may be empty. In this case, one approach is to directly output a zero value. If there is a large difference between the previous audio data value and the zero value, a sudden voltage change may be produced in the analog audio output, leading to pop noise in connected earphones or speakers. Another approach is to maintain the output of the last audio data value. Although this method can avoid pop noise, continuously outputting a fixed voltage may damage the earphones or speakers if the system fails to replenish the FIFO buffer with new audio data for an extended period.

### SUMMARY

Embodiments of the present disclosure provide a sound output device and an audio data interruption protection method thereof to avoid an occurrence of pop noise.

Embodiments of the present disclosure provide a sound output device and an audio data interruption protection method thereof to prevent damage to earphones or speakers when a first-in-first-out buffer cannot be replenished with new audio data for a long time.

An embodiment of the present disclosure provides a sound output device for driving a speaker equipment, including: a First-In-First-Out (FIFO) buffer, a buffer circuit, and a pop noise protection device. The FIFO buffer is configured to receive audio data and output the audio data according to an order of input. The buffer circuit is coupled to the FIFO buffer and configured to temporarily store the received audio data. The pop noise protection device is coupled to the FIFO buffer and the buffer circuit and configured to receive the audio data from the buffer circuit to drive the speaker equipment. When the pop noise protection device receives an underflow notification from the FIFO buffer, the pop noise protection device obtains the last audio data from the buffer circuit to drive the speaker equipment and continues gradually reducing volume of the last audio data.

Another embodiment of the present disclosure provides an audio data interruption protection method of a sound output device for protecting a speaker equipment, including: providing a First-In-First-Out (FIFO) buffer; providing a buffer circuit, which is coupled to the FIFO buffer and configured to temporarily store audio data received from the FIFO buffer; determining whether an underflow occurs in the FIFO buffer; when the underflow occurs in the FIFO buffer, extracting the last audio data from the buffer circuit to drive the speaker equipment; and gradually reducing volume of the last audio data.

According to the sound output device and the audio data interruption protection method thereof described in the preferred embodiment of the present disclosure, the pop noise protection device includes: a volume control circuit and a first multiplexer circuit. The volume control circuit is coupled to the buffer circuit and for receiving the last audio data and output a volume adjustment sound signal for gradually reducing the volume. The first multiplexer circuit includes a first input terminal, a second input terminal, a selection terminal, and an output terminal. The first input terminal of the first multiplexer circuit is coupled to the buffer circuit, the second input terminal of the first multiplexer circuit is coupled to the volume control circuit, the selection terminal of the first multiplexer circuit is coupled to the FIFO buffer, and when the FIFO buffer sends the underflow notification, the second input terminal of the first multiplexer circuit is electrically connected to the output terminal of the first multiplexer circuit.

According to the sound output device and the audio data interruption protection method thereof described in the preferred embodiment of the present disclosure, the pop noise protection device further includes: a second multiplexer circuit. The second multiplexer circuit includes a first output terminal, a second output terminal, a selection terminal, and an input terminal. The input terminal of the second multiplexer circuit is coupled to the buffer circuit, the first output terminal of the second multiplexer circuit is coupled to the first input terminal of the first multiplexer circuit, the second output terminal of the second multiplexer circuit is coupled to the volume control circuit, the selection terminal of the second multiplexer circuit is coupled to the FIFO buffer, and when the FIFO buffer sends the underflow notification, the input terminal of the second multiplexer circuit is electrically connected to the second output terminal of the second multiplexer circuit.

According to the sound output device and the audio data interruption protection method thereof described in the preferred embodiment of the present disclosure, the sound output device further includes: a counter circuit. The counter circuit includes an input terminal and an output terminal. The input terminal of the counter circuit is coupled to the FIFO buffer, the output terminal of the counter circuit is coupled to the selection terminal of the first multiplexer circuit and the selection terminal of the second multiplexer circuit, and when the FIFO buffer sends the underflow notification, the counter circuit starts counting a count value, and when the count value reaches a preset value, the counter circuit controls the second input terminal of the first multiplexer circuit to be electrically connected to the output terminal of the first multiplexer circuit and controls the output terminal of the second multiplexer circuit to be electrically connected to the second output terminal of the second multiplexer circuit.

According to the sound output device and the audio data interruption protection method thereof described in the preferred embodiment of the present disclosure, the volume control circuit includes: a volume adjustment module and a volume comparison module. The volume adjustment module includes an input terminal, an output terminal, and an adjustment terminal, wherein the input terminal of the volume adjustment module is coupled to the buffer circuit, and the output terminal of the volume adjustment module is coupled to the speaker equipment. The volume comparison module includes an input terminal and an output terminal, wherein the input terminal of the volume comparison module is coupled to the output terminal of the volume adjustment module, and the output terminal of the volume comparison module is coupled to the adjustment terminal of the volume adjustment module. When the FIFO buffer sends the underflow notification, the volume comparison module compares signal amplitude at its input terminal with signal amplitude of an expected value to output an adjustment signal to the adjustment terminal of the volume adjustment module. The volume adjustment module adjusts amplitude of signal at the output terminal of the volume adjustment module according to the adjustment signal.

As described above, when underflow occurs in the FIFO buffer, embodiments of the present disclosure starts performing a pop noise protection mechanism. The last audio data is first used to drive the speaker equipment. Then, if the underflow continues occurring, the volume of the last audio data is continuously reduced. This effectively prevents sudden pops of noise caused by interruptions of the audio data, while simultaneously protecting the speaker equipment and the hearing of users.

To further understand the technology, means, and effects of the present disclosure, reference may be made by the detailed description and drawing as follows. In this way, the purposes, features and concepts of the present disclosure can be thoroughly and concretely understood. However, the following detail description and drawings are only used to reference and illustrate the implementation of the present disclosure, and they are not used to limit the present disclosure.

### BRIEF DESCRIPTION OF THE DRAWINGS

The drawings are provided to make the persons with ordinary knowledge in the field of the art further understand the present disclosure, and are incorporated into and constitute a part of the specification of the present disclosure. The drawings illustrate demonstrated embodiments of the present disclosure, and are used to explain the principal of the present disclosure together with the description of the present disclosure.

FIG. 1 is a schematic circuit block diagram of a sound output device according to a preferred embodiment of the present disclosure.

FIG. 2 is a schematic circuit block diagram of a sound output device according to a preferred embodiment of the present disclosure.

FIG. 3 is a schematic flow chart of an audio data interruption protection method of a sound output device according to a preferred embodiment of the present disclosure.

FIG. 4 is a schematic flow chart of an audio data interruption protection method of a sound output device according to a preferred embodiment of the present disclosure.

### DESCRIPTION OF THE PREFERRED EMBODIMENTS

The embodiments of the present disclosure are described in detail as reference, and the drawings of the present disclosure are illustrated. In the case of possibility, the element symbols are used in the drawings to refer to the same or similar components. In addition, the embodiment is only one approach of the implementation of the design concept of the present disclosure, and the following multiple embodiments are not intended to limit the present disclosure.

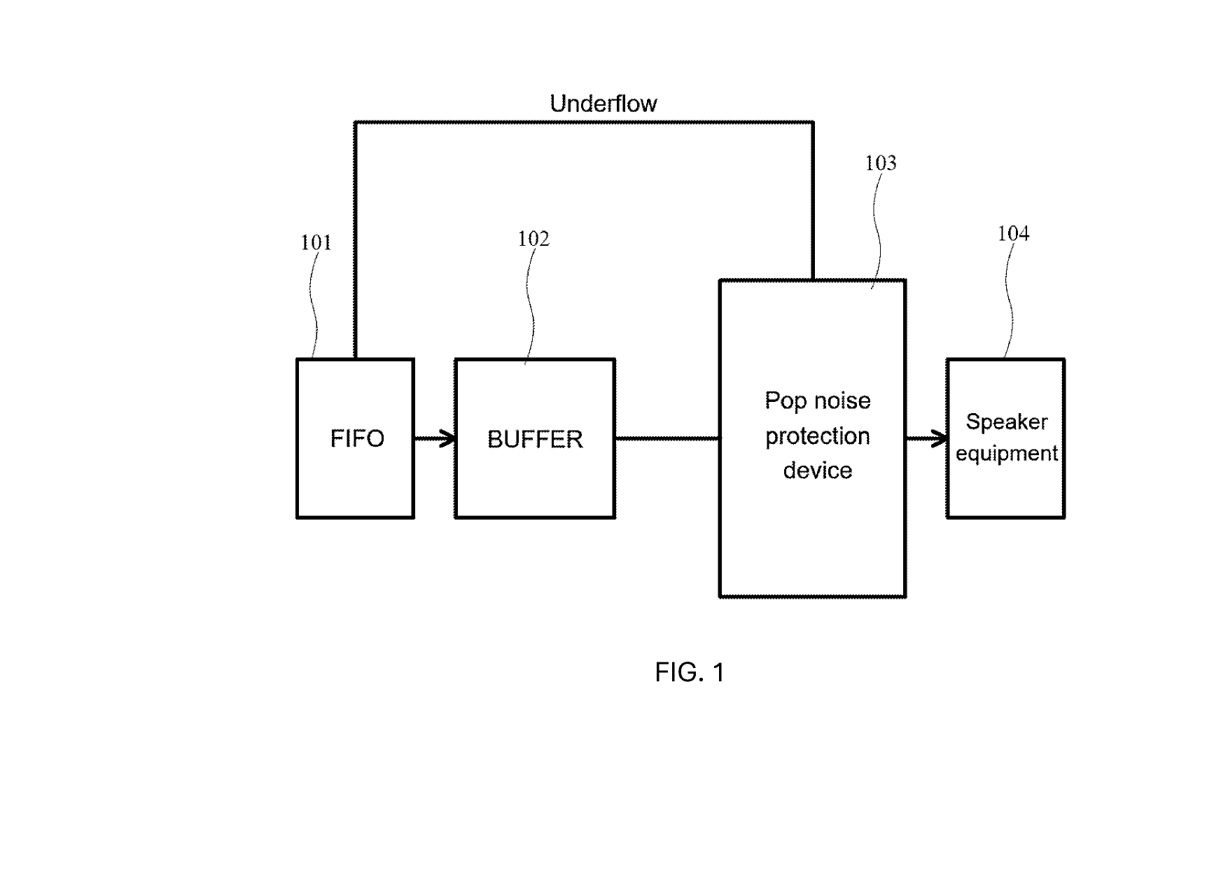

FIG. 1 is a schematic circuit block diagram of a sound output device according to a preferred embodiment of the present disclosure. Please refer to FIG. 1, the sound output device, for example, is a device used for processing digital sound and driving a speaker equipment 104. The sound output device includes a First-In-First-Out (FIFO) buffer 101, a buffer circuit 102, and a pop noise protection device 103. The FIFO buffer 101 is for receiving audio data and outputting the audio data in a first-in-first-out manner according to an order of input. The buffer circuit 102 is coupled to the FIFO buffer 101 and for temporarily storing the received audio data. Specifically, it may be implemented using, for example, a latch circuit.

The pop noise protection device 103 is coupled to the FIFO buffer 101 and the buffer circuit 102. During a normal operation, the pop noise protection device 103 receives the audio data from the buffer circuit 102 and converts it into an analog sound signal to drive the speaker equipment 104, such as earphones or a speaker. However, when the FIFO buffer 101 fails to properly receive audio data due to network instability or other reasons, the FIFO buffer 101 will continue providing data to the buffer circuit 102 until it runs out of data, resulting in underflow. At this point, the pop noise protection device 103 receives an underflow notification from the FIFO buffer 101. Then, the pop noise protection device 103 obtains the last audio data from the buffer circuit 102 to drive the speaker equipment 104. When the underflow continues occurring in the FIFO buffer 101 (i.e., the FIFO buffer 101 continues experiencing the underflow), the pop noise protection device 103 gradually reduce volume of the last audio data according to time, so that the user can hear a smooth fade-out of the last sound from the speaker equipment 104.

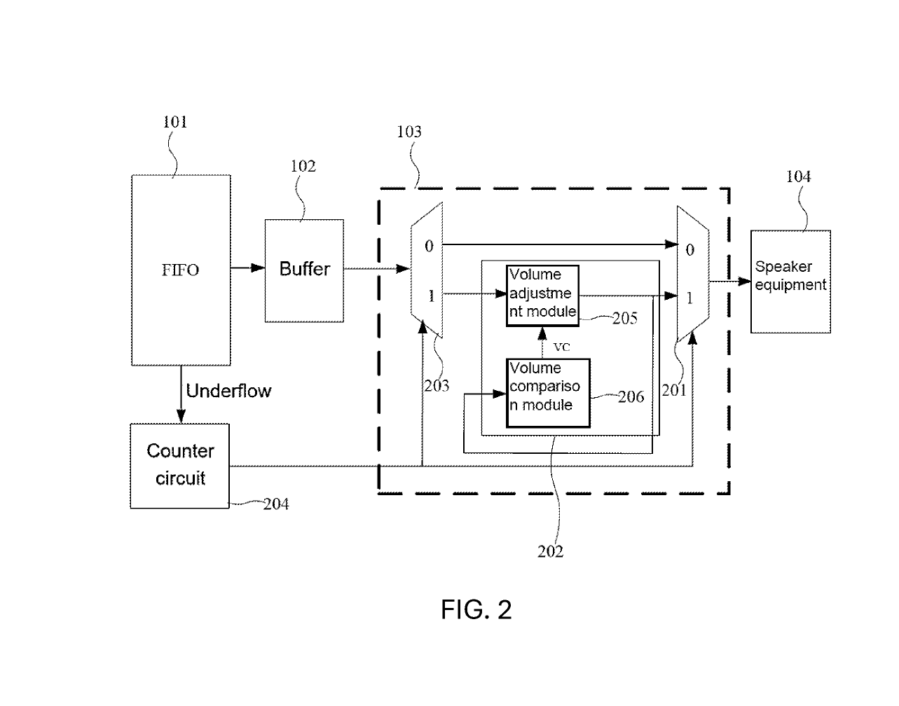

FIG. 2 is a schematic circuit block diagram of a sound output device according to a preferred embodiment of the present disclosure. Please refer to FIG. 2, the pop noise protection device 103 includes a first multiplexer circuit 201, a volume control circuit 202, and a second multiplexer circuit 203 in this embodiment. Additionally, the sound output device includes a counter circuit 204. The first multiplexer circuit 201 includes a first input terminal, a second input terminal, and an output terminal. The second multiplexer circuit 203 includes an input terminal, a first output terminal, and a second output terminal. In the case of a normal operation, the output terminal of the counter circuit 204 in this embodiment outputs logic “0.” Thus, the first input terminal of the first multiplexer circuit 201 is electrically connected to the output terminal, and the first output terminal of the second multiplexer circuit 203 is electrically connected to the input terminal. At this time, the audio data is sent from the FIFO buffer 101 to the buffer circuit 102 and then sent through the second multiplexer circuit 203 and the first multiplexer circuit 201 to the speaker equipment 104.

When the underflow occurs in the FIFO buffer 101, the counter circuit 204 immediately receives the underflow notification. At this time, the counter circuit 204 starts counting a count value but still outputs logic “0.” Thus, the last audio data is sent from the buffer circuit 102 through the second multiplexer circuit 203 and the first multiplexer circuit 201 to the speaker equipment 104. When the underflow continues occurring in the FIFO buffer 101 and the counter circuit 204 has counted the count value up to a preset value, the counter circuit 204 outputs logic “1.” At this time, the second input terminal of the first multiplexer circuit 201 is electrically connected to the output terminal, and the second output terminal of the second multiplexer circuit 203 is electrically connected to the input terminal. Thus, the last audio data is sent from the buffer circuit 102 through the second multiplexer circuit 203 to the volume control circuit 202. The volume control circuit 202 gradually reduces the playback volume of the last segment of valid audio data within a specific time period, resulting in a smooth fade-out.

In this embodiment, the volume control circuit 202 is implemented using a volume adjustment module 205 and a volume comparison module 206. The volume adjustment module 205 includes an input terminal, an output terminal, and an adjustment terminal. The input terminal of the volume adjustment module 205 is coupled to the second output terminal of the second multiplexer circuit 203 and coupled to the buffer circuit 102 through the second multiplexer circuit 203. The input terminal of the volume comparison module 206 is coupled to the output terminal of the volume adjustment module 205. The output terminal of the volume comparison module 206 is coupled to the adjustment terminal of the volume adjustment module. The volume comparison module 206 compares signal amplitude at its input terminal with signal amplitude of an expected value to output an adjustment signal VC to the adjustment terminal of the volume adjustment module 205. Thereby, the volume adjustment module 205 adjusts amplitude of signal at its output terminal according to the adjustment signal VC and gradually reduces playback volume of the last valid segment of the audio data.

In the aforementioned embodiment, although the first multiplexer circuit 201 and the second multiplexer circuit 203 are used, those skilled in the art should understand that the second multiplexer circuit 203 may not be an essential component. In this embodiment, when the second multiplexer circuit 203 is present and no underflow occurs, no signal will enter the volume control circuit 202. At this time, the volume control circuit 202 may enter a low-power consumption mode, thereby saving energy. However, those skilled in the art may remove the second multiplexer circuit 203 and alternatively use an enabling signal, allowing the audio data to be input directly into the volume control circuit 202, but making the volume control circuit 202 not to operate. Thus, the presence or absence of the second multiplexer circuit 203 is a design choice, and the present disclosure is not limited herein.

In addition, in the aforementioned embodiment, although the counter circuit 204 receives the underflow notification sent by the FIFO buffer 101 and counts, those skilled in the art should understand that the second multiplexer circuit 203 and the first multiplexer circuit 201 may be switched even without the counter circuit 204. Thus, the counter circuit 204 is a design choice (i.e., optional component) rather than an essential component, and the present disclosure is not limited herein. Similarly, although the volume control circuit 202 is implemented using the volume adjustment module 205 and the volume comparison module 206, those skilled in the art should understand that there are various implementation ways to gradually reduce the amplitude of the audio data, and the present disclosure is not limited herein.

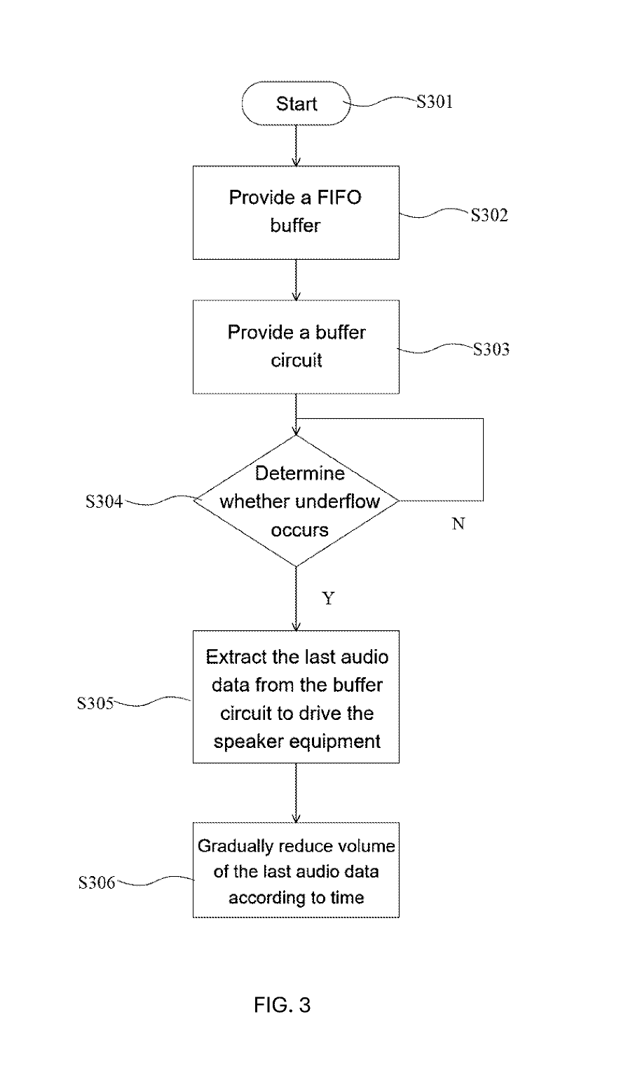

According to the aforementioned embodiments, an audio data interruption protection method of a sound output device may be summarized. FIG. 3 is a schematic flow chart of an audio data interruption protection method of a sound output device according to a preferred embodiment of the present disclosure. Please refer to FIG. 3, the audio data interruption protection method of the sound output device includes the following steps:

Step S301: Start.

Step S302: Provide a FIFO buffer.

Step S303: Provide a buffer circuit, coupled to the FIFO buffer, for temporarily storing audio data received from the FIFO buffer.

Step S304: Determine whether underflow occurs in the FIFO buffer(i.e., the FIFO buffer experiences the underflow or not). When it is determined that the underflow occurs in the FIFO buffer, step S305 is performed. When it is determined that the underflow does not occur, return to step S304 to continue the determination.

Step S305: Extract the last audio data from the buffer circuit to drive the speaker equipment.

Step S306: Gradually reduce volume of the last audio data according to time. When the underflow continues occurring in the FIFO buffer, continue gradually reducing the volume of the last audio data so that the sound played by the last audio data fades out smoothly.

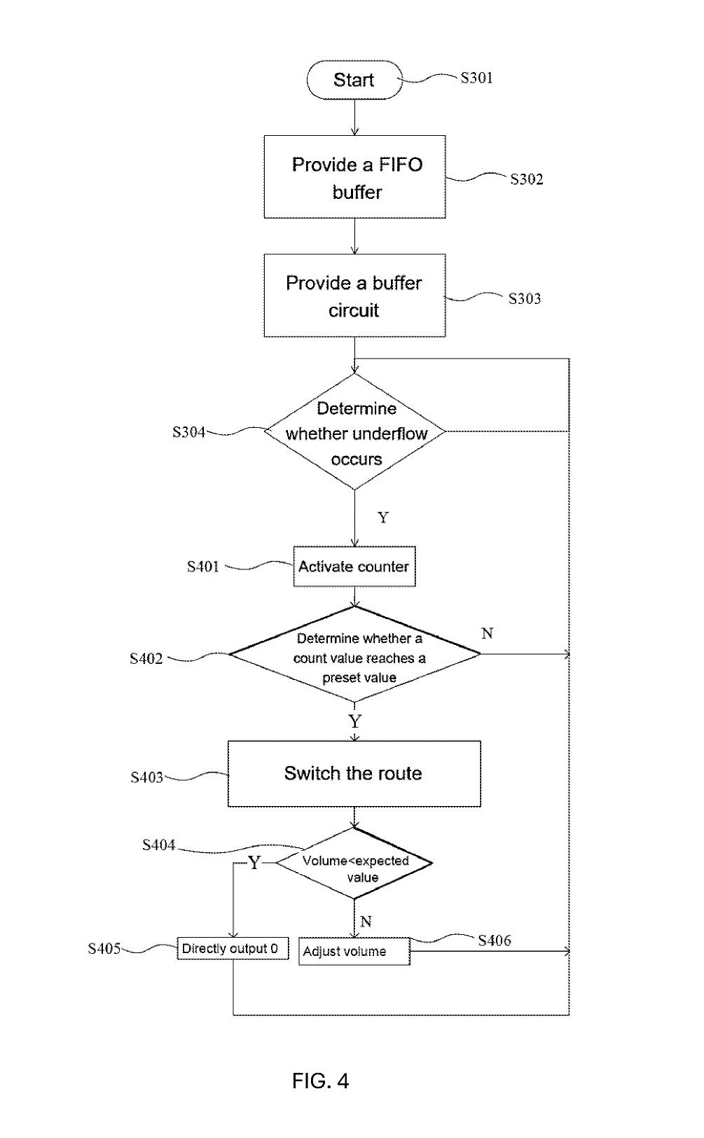

FIG. 4 is a schematic flow chart of an audio data interruption protection method of a sound output device according to a preferred embodiment of the present disclosure. Please refer to FIG. 4, the audio data interruption protection method of the sound output device includes the following steps in the case of the circuit in FIG. 2:

Step S301-Step S304: The steps are as described above.

Step S401: When it is determined that the underflow occurs in step S304, the counter circuit performs counting.

Step S402: Determine whether a count value of a counter circuit reaches a preset value.

Step S403: When the count value of the counter circuit reaches the preset value, switch the multiplexer circuit to route the audio data through the path of the volume control circuit 202.

Step S404: Determine whether a volume value reaches an expected value. When the volume value does not reach the expected value, step S406 is performed. When the volume value reaches the expected value, step S405 is performed.

Step S405: Directly output volume “0” and return to step S304.

Step S406: Reduce volume and return to step S304.

In summary, the preferred embodiment of the present disclosure continuously/instantly monitors the status of the FIFO buffer during operation. When it finds that underflow is about to occur due to the reading depletion of audio data in the FIFO buffer, a protection procedure is activated. This procedure repeatedly plays the last valid segment of the audio data in the buffer to prevent popping or crackling noises caused by interruptions. When the buffer does not receive new audio data for an extended period, the system gradually reduces the volume of the last valid segment of the audio data, resulting in a smooth fade-out. Thus, embodiments of the present disclosure not only protects the hardware but also provides users with a pleasant audio experience. By intelligently anticipating and smoothly handling interruptions of the audio data, it minimizes auditory discomfort and ensures a seamless, natural sound experience for users.

It should be understood that the examples and the embodiments described herein are for illustrative purpose only, and various modifications or changes in view of them will be suggested to those skilled in the art, and will be comprised in the spirit and scope of the application and the appendix with the scope of the claims.

What is claimed is:

1. A sound output device for driving a speaker equipment, comprising:
a First-In-First-Out (FIFO) buffer configured to receive audio data and output the audio data according to an order of input;
a buffer circuit, coupled to the FIFO buffer, configured to temporarily store the received audio data; and
a pop noise protection device, coupled to the FIFO buffer and the buffer circuit, configured to receive the audio data from the buffer circuit to drive the speaker equipment, wherein:
when the pop noise protection device receives an underflow notification from the FIFO buffer, the pop noise protection device obtains the last audio data from the buffer circuit to drive the speaker equipment and continues gradually reducing volume of the last audio data.

2. The sound output device according to claim 1, wherein the pop noise protection device comprises:
a volume control circuit, coupled to the buffer circuit, and configured to receive the last audio data and output a volume adjustment sound signal for gradually reducing the volume; and
a first multiplexer circuit comprising a first input terminal, a second input terminal, a selection terminal, and an output terminal, wherein the first input terminal of the first multiplexer circuit is coupled to the buffer circuit, the second input terminal of the first multiplexer circuit is coupled to the volume control circuit, the selection terminal of the first multiplexer circuit is coupled to the FIFO buffer, and when the FIFO buffer sends the underflow notification, the second input terminal of the first multiplexer circuit is electrically connected to the output terminal of the first multiplexer circuit.

3. The sound output device according to claim 2, wherein the pop noise protection device further comprises:
a second multiplexer circuit comprising a first output terminal, a second output terminal, a selection terminal, and an input terminal, wherein the input terminal of the second multiplexer circuit is coupled to the buffer circuit, the first output terminal of the second multiplexer circuit is coupled to the first input terminal of the first multiplexer circuit, the second output terminal of the second multiplexer circuit is coupled to the volume control circuit, the selection terminal of the second multiplexer circuit is coupled to the FIFO buffer, and when the FIFO buffer sends the underflow notification, the input terminal of the second multiplexer circuit is electrically connected to the second output terminal of the second multiplexer circuit.

4. The sound output device according to claim 3, wherein the sound output device further comprises:
a counter circuit comprising an input terminal and an output terminal, wherein the input terminal of the counter circuit is coupled to the FIFO buffer, the output terminal of the counter circuit is coupled to the selection terminal of the first multiplexer circuit and the selection terminal of the second multiplexer circuit, and when the FIFO buffer sends the underflow notification, the counter circuit starts counting a count value, and when the count value reaches a preset value, the counter circuit controls the second input terminal of the first multiplexer circuit to be electrically connected to the output terminal of the first multiplexer circuit and controls the output terminal of the second multiplexer circuit to be electrically connected to the second output terminal of the second multiplexer circuit.

5. The sound output device according to claim 2, wherein the volume control circuit comprises:
a volume adjustment module comprising an input terminal, an output terminal, and an adjustment terminal, wherein the input terminal of the volume adjustment module is coupled to the buffer circuit, and the output terminal of the volume adjustment module is coupled to the speaker equipment; and
a volume comparison module comprising an input terminal and an output terminal, wherein the input terminal of the volume comparison module is coupled to the output terminal of the volume adjustment module, and the output terminal of the volume comparison module is coupled to the adjustment terminal of the volume adjustment module,
wherein when the FIFO buffer sends the underflow notification, the volume comparison module compares signal amplitude at its input terminal with signal amplitude of an expected value to output an adjustment signal to the adjustment terminal of the volume adjustment module, wherein the volume adjustment module adjusts amplitude of signal at the output terminal of the volume adjustment module according to the adjustment signal.

6. An audio data interruption protection method of a sound output device for protecting a speaker equipment, comprising:
providing a First-In-First-Out (FIFO) buffer;
providing a buffer circuit, which is coupled to the FIFO buffer and configured to temporarily storing audio data received from the FIFO buffer;
determining whether an underflow occurs in the FIFO buffer;
when the underflow occurs in the FIFO buffer, extracting the last audio data from the buffer circuit to drive the speaker equipment; and
gradually reducing volume of the last audio data.

7. The audio data interruption protection method of the sound output device according to claim 6, wherein when the underflow occurs in the FIFO buffer, the audio data interruption protection method further comprises:
performing counting to accumulate a count value;
determining whether the count value reaches a threshold; and
when the count value reaches the threshold, starting gradually reducing volume of the last audio data.

8. The audio data interruption protection method of the sound output device according to claim 6, wherein when the count value does not reach the threshold and the FIFO buffer recovers from the underflow, the audio data interruption protection method further comprises:
returning to the step of determining whether the underflow occurs in the FIFO buffer.
